(19) United States
(12) Patent Application Publication
(10) Pub. No.: US 2008/0100517 A1
(43) Pub. Date: May 1, 2008

(54) Internet communication system

(76) Inventor: Brian D. Shaver, Chandler, AZ (US)

Correspondence Address: TOD R NISSLE, PO BOX 55630, PHOENIX, AZ, 85078, US

(21) Appl. No.: 11/588,724

(22) Filed: Oct. 27, 2006

(51) Int. Cl. H01Q 1/24

(52) U.S. Cl. 343/702

(57) ABSTRACT

An Internet communication system includes a satellite; a computer; and an antenna unit connected to the computer to communicate with the satellite. The antenna unit comprises a housing; an antenna mounted in said housing and rotatable about a generally vertical axis while remaining in a generally horizontal plane. The antenna comprises a flexible polymer face that remains in a fixed canted orientation while the antenna rotates in said horizontal plane, and a linear metal antenna strip array on the face. The antenna has an antenna pattern with an elevation in the range of zero to ninety degrees and with a beam width of no more than six degrees.

This invention relates to Internet satellite communication systems.

More particularly, the invention relates to a portable wireless computer system for communicating with the Internet via satellite.

Conventional wireless Internet satellite communication systems comprise a computer, a transceiver connected to the computer, an antenna system connected to the transceiver, and a satellite which communicates with the computer via the antenna system. Prior art antenna systems typically cost between $1,000.00 and $10,000.00, which cost may or may not include the cost of a transceiver to interface between the antenna system and a computer. Many of such prior art transceiver antenna systems are large and are not readily disassembled and transported from one location to another, nor are they capable of maintaining an Internet connection while moving from location to location.

Accordingly, it would be highly desirable to provide an improved, readily transported, inexpensive, easy-to-install, wireless computer system for communicating with the Internet via satellite when the system is stationary or used while moving from location to location.

Therefore, it is a principal object of the instant invention to provide an improved satellite Internet communication system.

A further object of the invention is to provide an improved Internet communication system that simplifies the assembly of the antenna system, transceiver, and computer.

These and other, further and more specific objects and advantages of the invention will be apparent to those of skill in the art from the following detailed description thereof, taken in conjunction with the drawings, in which:

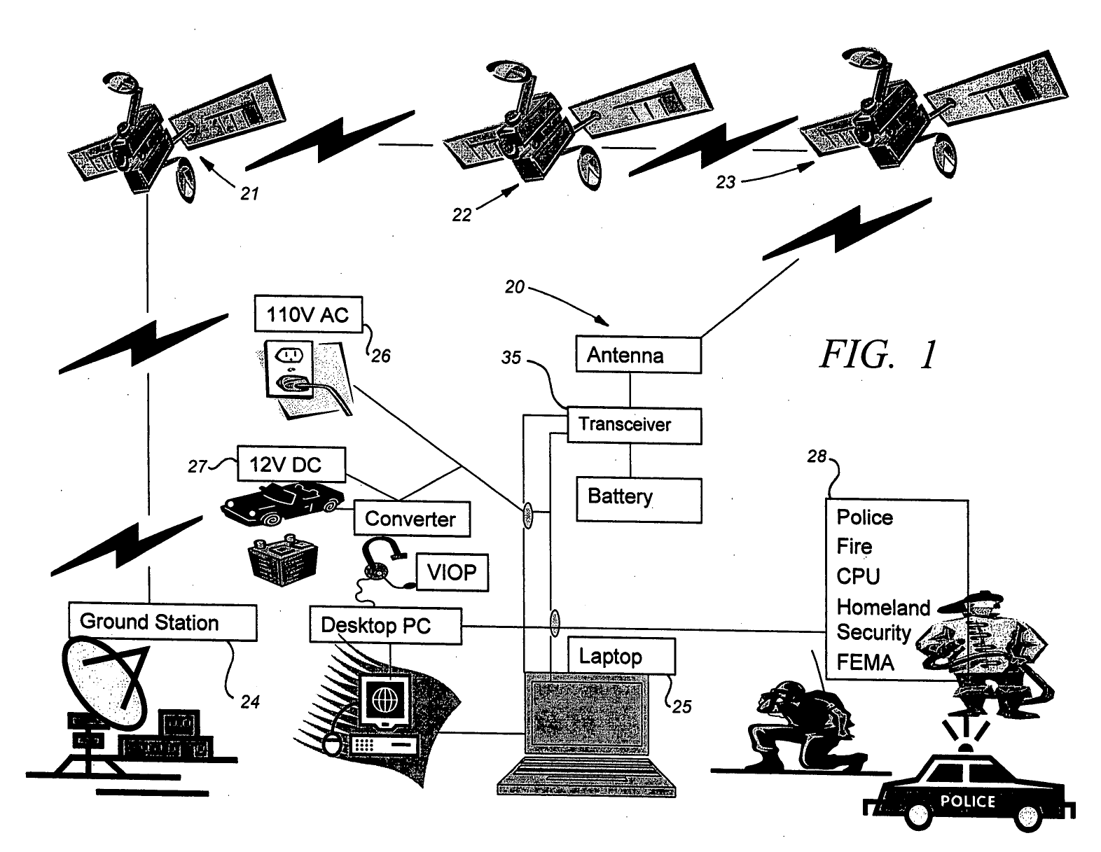

FIG. 1 is a diagram illustrating the Internet communication system of the invention;

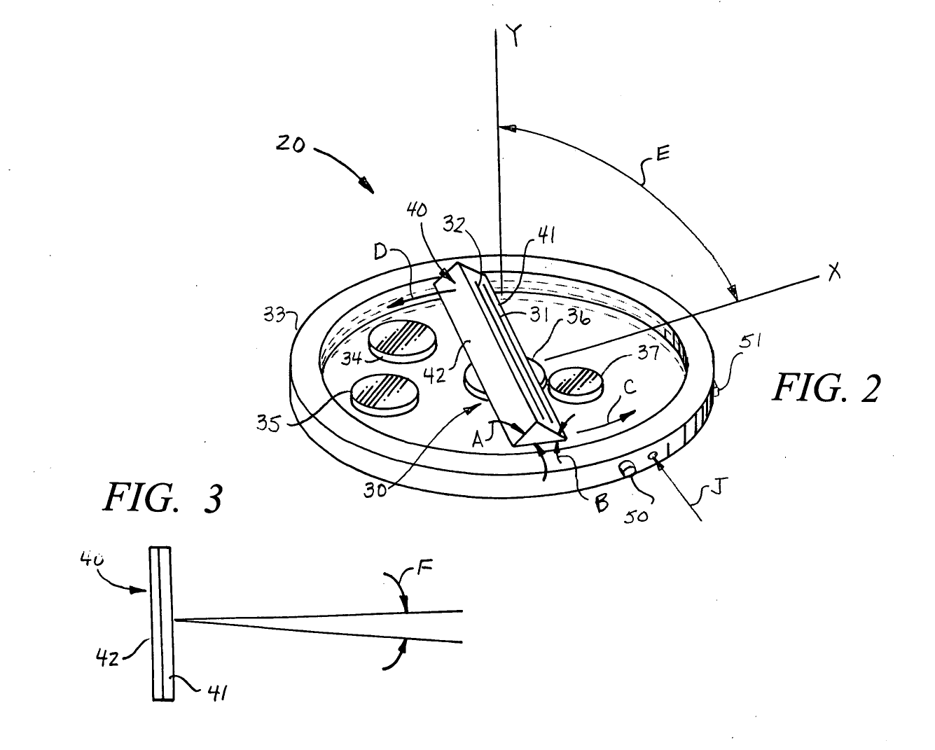

FIG. 2 is a perspective view illustrating an antenna system utilized in the Internet communication system of the invention;

FIG. 3 is a top view illustrating the beam width of the antenna signal in the antenna system of FIG. 3;

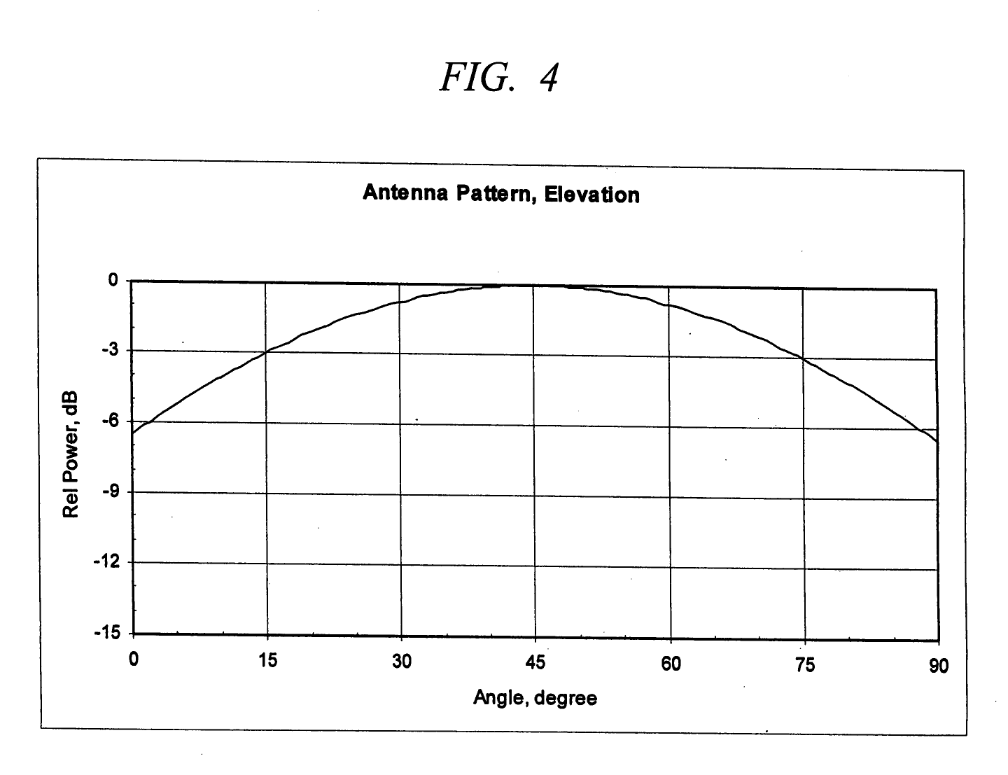

FIG. 4 is a graph illustrating the antenna signal elevation pattern produced by the antenna system of FIG. 3;

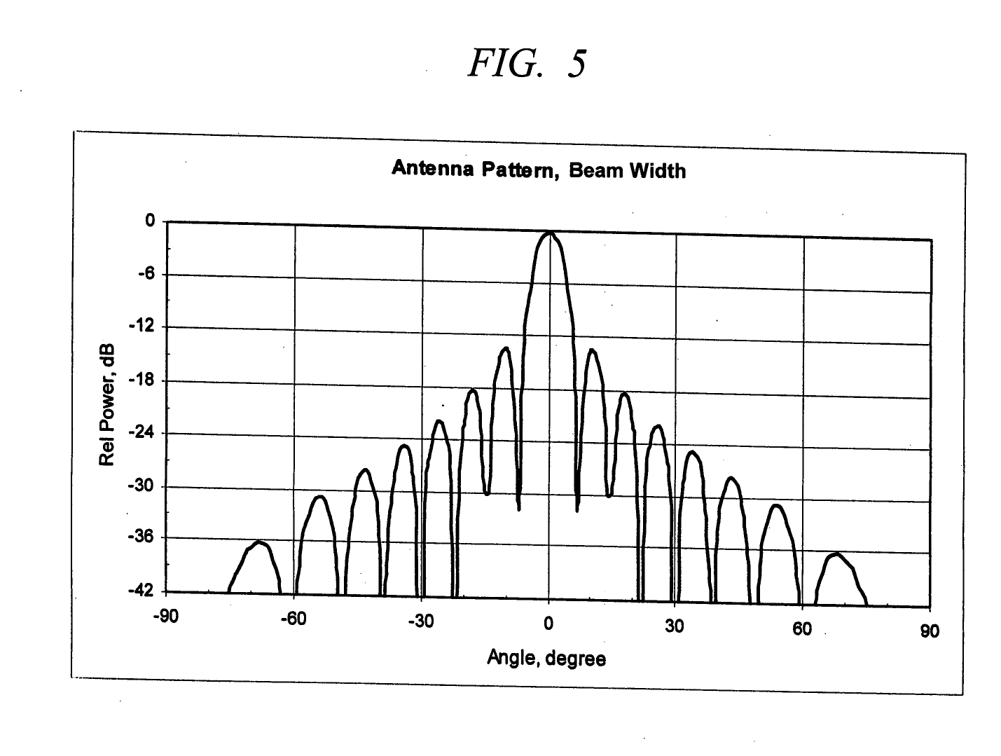

FIG. 5 is a graph illustrating the antenna signal beam width pattern produced by the antenna system of FIG. 3; and,

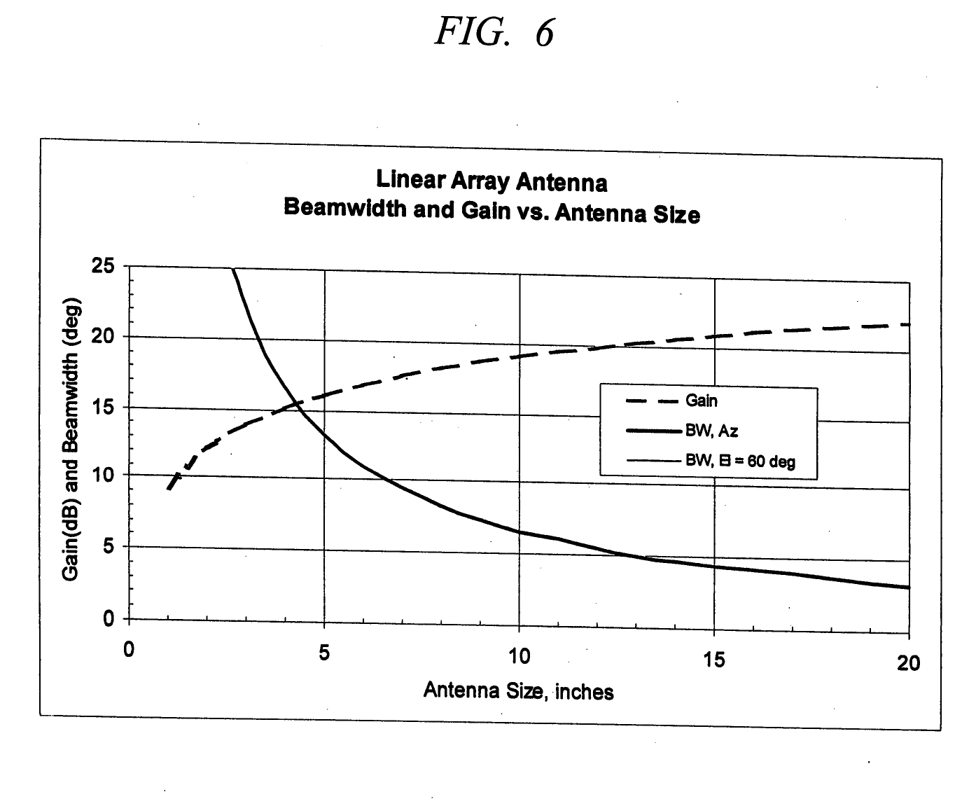

FIG. 6 is a graph illustrating antenna beam wide and gain in relation to the size, or length, of an antenna.

Briefly, in accordance with the invention, I provide an improved system for communicating with the Internet via satellite. The communication system comprises a satellite, a computer, and an antenna unit connected to the computer to facilitate two-way communication with the satellite. The antenna unit comprises a housing; an antenna mounted in the housing and rotatable about a generally vertical axis while remaining in a generally horizontal plane and including a face that remains in a fixed canted orientation while the antenna rotates in the horizontal plane; and a linear antenna strip array on the face. The antenna has an antenna signal pattern with an elevation in the range of about zero to ninety degrees and with a beam width of no more than six degrees. A transceiver is mounted in the housing.

In another embodiment of the invention, I provide an improved system for communicating with the Internet via satellite. The system comprises a satellite, a computer, and an antenna unit connected to the computer to communicate with the satellite. The antenna unit comprises a housing; an antenna mounted in the housing and rotatable about a generally vertical axis while remaining in a generally horizontal plane and including a polymer face that remains in a fixed canted orientation while the antenna rotates in the horizontal plane; and a linear metal antenna strip array on the face. The antenna has an antenna pattern with an elevation in the range of zero to ninety degrees and with a beam width of no more than six degrees.

Turning now to the drawings, which depict the presently preferred embodiments of the invention for purposes of illustration and not by way of limitation of the invention, and in which like reference characters refer to corresponding elements throughout the several views, FIG. 1 illustrates an Internet communication system constructed in accordance with the invention and including a computer 25, antenna system 20, satellites 21 to 23, and ground station 24. Ground station 24 typically includes a server or other link to the Internet. Satellites 21 to 23 communicate with each other and transmit signals and data between station 24 and computer 25. Antenna system 20 includes transceiver 35, and is powered by a battery, by a connection to a 120 V wall outlet 26, by a twelve volt converter 27 in a vehicle, by rechargeable batteries, by a solar-powered energy source, or by any other desired power source. Computer 25 or a satellite 23 can communicate with a variety of sources 28 including but not limited to the police, firemen, another computer, homeland security, FEMA.

The antenna unit 20 is illustrated in more detail in FIG. 2 and includes a base, or housing, 33. Antenna 40 is mounted in housing 33 on a gear box 36 that rotatably drives antenna 40 in the directions indicated by arrows C and D. When antenna 40 locates a desired satellite, antenna 40 stops rotating and “fixes” or locks on the signal from satellite 23. Antenna 40 then moves only when it is necessary to maintain the directional focus of antenna 40 on the satellite 23. Motor 37 powers gear box 36. Transceiver 35 is mounted in housing 33 and sends and receives signals via antenna 30. Microprocessor 34 is mounted in housing 33 and controls the transceiver 35 and motor 37. Antenna faces 41 and 42 are at angles B and A, respectively, to the base of antenna 40. Angles A and B preferably each equal about forty-five degrees.

The divergence, or beam width, of a signal from antenna 40 in a generally horizontal plane is relatively narrow, as indicated by arrow F in FIG. 3, and is presently about six degrees. FIG. 3 is a top view of antenna 40 illustrating the beam width as indicated by arrows F. The beam width is no more than six degrees and is in the range of 0.25 degrees to six degrees, preferably is in the range of about one degree to six degrees, and most preferably in the range of about one degree to four degrees. FIG. 5 illustrates the beam width pattern of antenna 40.

In contrast to the signal beam width, the signal elevation E is, as indicated in FIG. 2, from zero degrees to ninety degrees. In other words, when looking at the beam width and elevation of the signal from antenna 40, the signal has a shape similar to that of an open Japanese fan. The signal elevation E can be in a more restricted range, for example fifteen degrees to eighty-five degrees, or, zero degrees to eighty degrees, or, five degrees to eighty-five degrees; however, the elevation E from about zero to ninety degrees is presently preferred in the practice of the invention.

The combination of beam width and elevation found in the signal from antenna 40 facilitates the antenna's finding a geosynchronous fixed GPS or other satellite 23 when antenna 40 is turning or sweeping in the direction of arrows C and D. Microprocessor 34 directs motor 37 to provide motive power to gear box 36 to turn antenna 40 in the direction of arrows C and D. Microprocessor 34 includes a global positioning (GPS) chip and an e-prom chip. The GPS chip utilizes data from a fixed GPS satellite to define the position on earth of antenna 40. The e-prom chip includes in memory the position and transmission frequencies of various satellites that are in geosynchronous orbit and transmit Internet and other data. When antenna unit 20 is moving, or stationary, microprocessor continuously checks and updates the position of unit 20 on the earth and, if necessary, positions antenna 40 to communicate with and transmit data to and from a selected geosynchronous satellite. Microprocessor 34 enables a PDA, I-Pod, mobile TV, or cell phone to be plugged directly into antenna unit 20. A computer interface is not required between unit 20 and a PDA, I-Pod, mobile TV, or cell phone. Further, as noted elsewhere herein, unit 20, including microprocessor 34, is designed to operate when plugged into a 110 volt wall outlet 26 or to utilize a twelve volt converter to plug into a 12V DC outlet.

Spaced apart, parallel, metal strips 31 and 32 are placed on only one face 41 of antenna 40 and preferably are formed or placed on a flexible mylar strip or another light-weight electrically insulative polymer or other material. The diameter of base 33 can vary as desired, but is preferably about twelve to eighteen inches. As the diameter of base 33, and therefore the length of antenna 40, increases from about twelve inches, the beam width of the antenna signal decreases to less than six degrees. This decrease in beam width is desirable. The increase in size of unit 20 is, however, undesirable because an important feature of the invention is the small size and portability of unit 20.

Another important feature of the invention is its utilization of a single antenna 40 with one to three parallel metal strips with an output that is, in the event a plurality of strips is utilized, ganged together.

A further important feature of the invention is the deposition or placing of metal strips 31, 32 on mylar or another light-weight, preferably flexible, material.

Still another important feature of the invention is the ability of antenna 40 to produce, in conjunction with its operative association with a computer and satellite, a fan-shaped signal that can readily detect satellites.

Still a further important feature of the invention is the utilization in housing 33 of a transceiver. This permits antenna unit 20 to be connected directly to a computer.

Antenna unit 20 can be readily utilized in adverse weather conditions. Many other prior art antennas are adversely affected by inclement weather conditions.

Power for unit 20 is provided by batteries that can be removably mounted in unit 20 or can be in a battery pack that is connected to or removably attached to unit 20 as indicated by arrow J in FIG. 2. AC 26 and DC 27 electricity can also, as shown in FIG. 1, be used to power unit 20.

In FIG. 2, axis X is normal to axis Y and is normally horizontal to base 33 and to the ground. Axis X, and base 33, preferably are upwardly canted from the ground by no more than fifteen degrees.

Having described the presently preferred embodiments and best mode of the invention in such terms as to enable those of skill in the art to understand and practice the invention, I claim:

1. A system for communicating with the Internet, comprising
(a) a satellite;
(b) a computer;
(c) an antenna unit connected to said computer to communicate with said satellite, said antenna unit comprising
(i) a housing;
(ii) an antenna mounted in said housing and rotatable about a generally vertical axis while remaining in a generally horizontal plane and including
a face that remains in a fixed canted orientation while said antenna rotates in said horizontal plane,
a linear antenna strip array on said face, said antenna having an antenna signal pattern with an elevation in the range of about zero to ninety degrees and with a beam width of no more than six degrees; and,
(iii) a transceiver mounted in said housing.

2. A system for communicating with the Internet, comprising
(a) a satellite;
(b) a computer;
(c) an antenna unit connected to said computer to communicate with said satellite, said antenna unit comprising
(i) a housing;
(ii) an antenna mounted in said housing and rotatable about a generally vertical axis while remaining in a generally horizontal plane and including
a flexible polymer face that remains in a fixed canted orientation while said antenna rotates in said horizontal plane,
a linear metal antenna strip array on said face, said antenna having an antenna pattern with an elevation in the range of zero to ninety degrees and with a beam width of no more than six degrees.
